(19) United States
(12) Patent Application Publication
(10) Pub. No.: US 2016/0116385 A1
(43) Pub. Date: Apr. 28, 2016

(54) SUBSTRATE FOR ADHESION OF BIOLOGICAL MATTER, AND PRODUCTION METHOD AND STORAGE METHOD FOR SAME

(71) Applicant: PANASONIC INTELLECTUAL PROPERTY MANAGEMENT CO., LTD., Osaka (JP)

(72) Inventor: TAKASHI SESEI, Osaka (JP)

(73) Assignee: PANASONIC INTELLECTUAL PROPERTY MANAGEMENT CO., LTD., Osaka (JP)

(21) Appl. No.: 14/787,463

(22) PCT Filed: May 28, 2014
(86) PCT No.: PCT/JP2014/002827

§ 371 Date: Oct. 27, 2015

(30) Foreign Application Priority Data
Jun. 14, 2013 (JP) 2013-125359

(51) Int. Cl. G01N 1/36; C09J 7/00

(52) U.S. Cl. CPC G01N 1/36; C09J 7/00; G01N 2001/364

(57) ABSTRACT

A biological-matter-adhesive substrate includes a base having a surface having a hydrophilicity configured to allow a biological matter to be bonded to the surface of the base. The surface of the base is covered with an acidic solution. This biological-matter-adhesive substrate maintains adhesiveness to a biological matter even if being stored for a long period of time.

### TECHNICAL FIELD

The present invention relates to a biological-matter-adhesive substrate configured to allow a biological matter, such as cells, blood cells, tissue, and biomolecules, to be bonded thereto, a method of producing the substrate, and a method of storing the biological-matter-adhesive substrate.

### BACKGROUND ART

In order to inspect and analyze a biological matter, such as cells, blood cells, tissue, and biomolecules, the biological matter may be bonded and fixed to a substrate. In this case the substrate is required to be hydrophilic.

Typical polymeric substrates are hydrophobic, and have a plasma treatment or ion beam treatment performed thereto. PTL 1 discloses that a polymeric substrate disposed in water or a vacuum after having plasma treatment or ion beam treatment performed thereto maintains the hydrophilicity of its surface over a long period of time.

The above method, however, may reduce the adhesiveness to a biological matter even if the hydrophilicity of the substrate is maintained. Further, the method incurs variations in the adhesiveness to a biological matter depending on a period of time for storing the material.

### CITATION LIST

### Patent Literature

PTL 1 Japanese Patent Laid-Open Publication No. 2006-282871

### SUMMARY

A biological-matter-adhesive substrate includes a base having a surface having a hydrophilicity configured to allow a biological matter to be bonded to the surface of the base. The surface of the base is covered with an acidic solution.

This biological-matter-adhesive substrate maintains adhesiveness to a biological matter even if being stored for a long period of time.

### BRIEF DESCRIPTION OF DRAWINGS

FIG. 1 is a perspective view of a biological-matter-adhesive device according to an exemplary embodiment.

FIG. 2 is a sectional view of the biological-matter-adhesive device along line 2-2 shown in FIG. 1.

FIG. 3 is a sectional view illustrating usage of a biological-matter-adhesive substrate according to the embodiment.

FIG. 4 is a sectional view of a biological-matter-adhesive substrate according to the embodiment for illustrating a usage thereof.

FIG. 5 is a sectional view of another biological-matter-adhesive device according to the embodiment.

### DETAIL DESCRIPTION OF PREFERRED EMBODIMENT

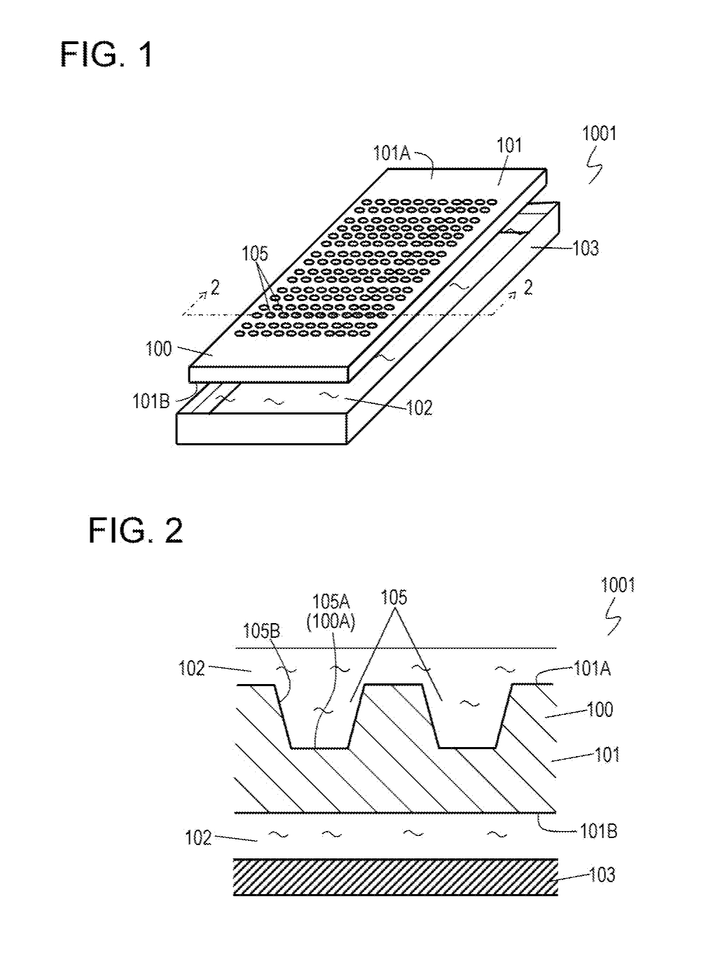

FIG. 1 is a perspective view of biological-matter-adhesive device 1001 according to an exemplary embodiment. FIG. 2 is a sectional view of biological-matter-adhesive device 1001 along line 2-2 shown in FIG. 1. Biological-matter-adhesive device 1001 includes biological-matter-adhesive substrate 100, acidic solution 102, and container 103 containing therein biological-matter-adhesive substrate 100 and acidic solution 102. Biological-matter-adhesive substrate 100 is disposed in acidic solution 102 inside container 103.

Biological-matter-adhesive substrate 100 includes base 101. Base 101 has a plate shape having surface 101A and surface 101B opposite to surface 101A. Surface 101A of base 101 has plural cavities 105 therein. Cavity 105 does not pass through base 101 and has side wall 105B connected to surface 101A of base 101, and bottom surface 105A connected to side wall 105B. Bottom surface 105A is surface 100A of base 101. Surface 100A is configured to allow a biological matter to be bonded to surface 100A. Surface 100A (bottom surface 105A) has a hydrophilization treatment performed thereto. While biological-matter-adhesive substrate 100 is disposed in acidic solution 102, surface 100A of base 101 is completely covered with acidic solution 102.

Base 101 is made of, e.g. a hydrophobic polymer. A hydrophobic polymer is a polymer having a contact angle to water not smaller than 30 degrees if the water is put on a surface of the polymer. Base 101 made of the hydrophobic polymer is made of at least one of polystyrene (PS), polymethyl methacrylate (PMMA), polycarbonate (PC), polypropylene (PP), polyethylene terephthalate (PET), polyethylene (PE), polymethylpentene (PMP), polylactic acid (PLA), cyclic olefin copolymer (COC), and cyclic olefin polymer (COP), for example. Alternatively, base 101 may be made of a material, such as glass, silicon, metal oxide, or metal, other than polymer.

The shape of biological-matter-adhesive substrate 100 (i.e., base 101) can be determined appropriately according to application purpose and is not especially limited. Examples of the shape include a board, a disk, a container, a film, and a tube. Further, surface 101A does not necessarily have plural cavities 105 therein; may have only one cavity 105; or may be flat. In this case, surface 101A of base 101 is configured to allow a biological matter to be bonded to surface 101A having a hydrophilization treatment performed thereto.

The size of biological-matter-adhesive substrate 100 can be determined appropriately according to its application purpose and is not especially limited.

The hydrophilization treatment is a process that reduces the contact angle of surface 100A (bottom surface 105A of cavity 105) of base 101 to water to an angle not larger than 20 degrees. The hydrophilization treatment is one of, e.g. a plasma treatment, a UV irradiation, a corona treatment, and a flame processing.

The plasma treatment is a modification treatment by cleaning in which plasma gas generated due to electric discharge in an atmosphere of an inactive gas is sprayed on surface 100A to decompose or remove an organic matter (e.g., oil) and water at a molecular level, or by introducing functional group. Examples of the inactive gas for the plasma treatment include nitrogen gas, argon gas, oxygen gas, helium gas, neon gas, and xenon gas.

The corona treatment is a surface modification process that uses a corona discharge to modify surface 100A. Unlike a surface process by plasma, the corona discharge applied to surface 100A changes the molecular structure of surface 100A due to collision of, e.g. electrons to roughen surface 100A. The corona treatment produces carboxyl groups and hydroxyl groups that are hydrophilic on surface 100A of base 101, thereby increasing wettability to water.

The UV irradiation is a process in which active oxygen formed by ultraviolet light is generated, and the active oxygen collides with surface 100A of base 101 to cut molecular chains in surface 100A and its vicinity for introducing new functional groups into surface 100A.

The flame processing is a process in which a flammable gas is burned while oxygen is blown to the gas to cause oxidation reaction for introducing functional groups into surface 100A.

The hydrophilization treatment performed to surface 100A of base 101 increases the hydrophilicity of surface 100A.

Base 101 having surface 100A having the hydrophilization treatment performed thereto is disposed in acidic solution 102.

Acidic solution 102 is a solution containing, e.g. carboxylic acid, sulfonic acid, or phosphonic acid and may employ acetic acid, citric acid, sulfuric acid, or phosphoric acid. Acidic solution 102 preferably has a pH value not larger than six, and more preferably has not larger than four.

If surface 100A previously has a hydrophilicity, surface 101A of base 101 does not necessarily have the hydrophilization treatment performed thereto.

Biological-matter-adhesive substrate 100 shown in FIGS. 1 and 2 can be produced as follows. First, base 101 is prepared. Base 101 has surface 100A having a hydrophilicity configured to allow a biological matter to be bonded to surface 100A. Then, surface 100A of base 101 is covered with acidic solution 102. Surface 100A of base 101 may be completely covered with acidic solution 102. Alternatively, base 101 may be disposed in acidic solution 102.

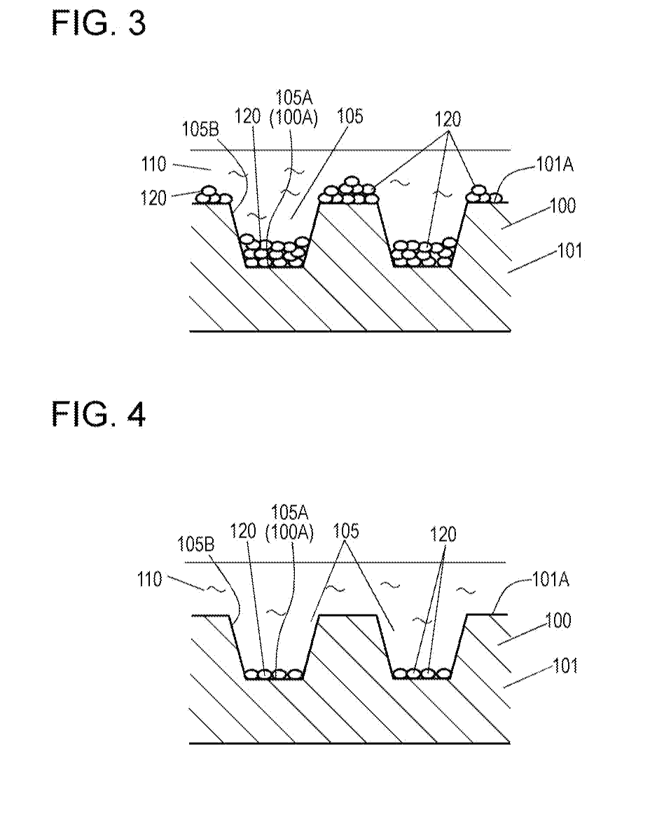

Advantages of biological-matter-adhesive substrate 100 having the hydrophilization treatment performed thereto and stored in acidic solution 102 will be described above. FIGS. 3 and 4 are sectional views of biological-matter-adhesive substrate 100 for illustrating a usage thereof. According to the embodiment, red blood cells as biological matter 120 are bonded to surface 100A (bottom surface 105A) in order to inspect the red blood cells.

Biological-matter-adhesive substrate 100 is taken out of acidic solution 102. Then, as shown in FIG. 3, specimen liquid 110 containing biological matter 120, red blood cells, is disposed on surface 101A of biological-matter-adhesive substrate 100 (base 101). Resultantly, biological matter 120 is deposited on bottom surface 105A (surface 100A) of cavity 105 and on surface 101A while having a multilayer structure. After that, surface 101A of biological-matter-adhesive substrate 100 (base 101) is cleaned, biological matter 120 is removed and separated from biological-matter-adhesive substrate 100 except for a portion of biological matter 120 contacting bottom surface 105A (surface 100A) of cavity 105. Resultantly, as shown in FIG. 4, biological matter 120 is bonded onto bottom surface 105A (surface 100A of base 101) of cavity 105 while having a single-layer structure.

Samples of base 101 of biological-matter-adhesive substrate 100 according to the embodiment were produced. Biological-matter-adhesive substrate 100 of Example 1 was stored in citric acid as acidic solution 102. Biological-matter-adhesive substrate 100 of Example 2 was stored in sulfuric acid as acidic solution 102. Biological-matter-adhesive substrate 100 of Example 3 was stored in phosphoric acid as acidic solution 102. Further, a biological-matter-adhesive substrate of Comparative Example 1 was stored in the atmosphere. A biological-matter-adhesive substrate of Comparative Example 2 was stored in pure water. TABLE 1 shows the contact angle to water of these samples of the biological-matter-adhesive substrates with respect to the storage time. The samples were stored at room temperature.

TABLE 1

| Storage | Comparative | Comparative | Example 1 | Example 2 | Example 3 |
|---|---|---|---|---|---|
| Time | Example 1 | Example 1 | citric | sulfuric | phosphoric |
| (months) | atmosphere | pure water | acid | acid | acid |
| 1 | 7 ± 2 | 7 ± 2 | 8 ± 2 | 2 ± 1 | 5 ± 1 |
| 1.5 | 23 ± 3 | 16 ± 2 | 7 ± 2 | 3 ± 1 | 3 ± 1 |
| 2 | 30 ± 3 | 15 ± 1 | 9 ± 1 | 4 ± 2 | 6 ± 1 |
| 3 | 38 ± 2 | 40 ± 4 | 7 ± 2 | 8 ± 2 | 14 ± 2 |

As shown in TABLE 1, Comparative Examples 1 and 2 stored in the atmosphere and pure water have contact angles to water which increase as the storage time increases and which exceed 30 degrees after three months elapse. Meanwhile, Examples 1 to 3 stored in acidic solution have contact angles not larger than 20 degrees even after three months elapse, thus maintaining hydrophilicity. The large contact angle of Comparative Example 1 results from that the biological-matter-adhesive substrate stored in the atmosphere was contaminated in the atmosphere. The large contact angle of Comparative Example 2 results from that hydrophilic functional groups introduced during the hydrophilization treatment execute molecular chain movement in the pure water to reduce the amount of the hydrophilic functional groups appearing on the surface of the base in the pure water more than in an acidic solution. It was confirmed that the contact angles to water of Examples 1 to 3 were maintained to be not larger than 30 degrees for a storage time not shorter than six months.

TABLE 2 shows the number of biological matters bonded to the substrate of each of Examples 1 to 3 of biological-matter-adhesive substrate 100 according to the embodiment, Comparative Example 1 stored in the atmosphere, and Comparative Example 2 stored in pure water.

Surface 100A of base 101 of Examples 1 to 3 has a circular shape with a radius of 34 μm and an area of about 3,600 μm². About hundred red blood cells, biological matter 120, can be boned to this area.

TABLE 2

| Storage | Comparative | Comparative | Example 1 | Example 2 | Example 3 |
|---|---|---|---|---|---|
| Time | Example 1 | Example 1 | citric | sulfuric | phosphoric |
| (months) | atmosphere | pure water | acid | acid | acid |
| 1 | 100 ± 5 | 101 ± 5 | 99 ± 2 | 98 ± 4 | 96 ± 3 |
| 1.5 | 85 ± 15 | 87 ± 15 | 99 ± 1 | 99 ± 2 | 97 ± 2 |
| 2 | 85 + 10/−15 | 87 ± 12 | 100 ± 3 | 99 ± 2 | 98 ± 2 |
| 3 | — | — | 97 ± 3 | 100 ± 2 | 99 ± 2 |

As shown in TABLE 2, in Comparative Example 1 stored in the atmosphere and Comparative Example 2 stored in pure water, the number of biological matters 120 bonded to the substrate significantly decreases and the variation of the number increases after a storage time of 1.5 months elapses. Especially in Comparative Example 1 stored in the atmosphere, a smaller number of biological matters 120 are bonded and the number has a larger variation than the other samples, both indicating remarkable deterioration in performance. Further, in Comparative Example 2 stored in pure water, a smaller number of biological matters 120 are bonded after a storage time of 1.5 months. Meanwhile, in Examples 1 to 3 stored in acidic solutions, a large number of biological matters 120 are bonded and the number has a small variation even after a storage time of three months. This results from that functional groups, such as carboxyl groups, out of functional groups introduced in the hydrophilization treatment especially contributing to bonding of biological matters prefer a homogeneous environment to appear on surface 100A of base 101.

Regarding the adhesiveness of biological matter 120, in Comparative Example 2 stored in pure water, a small number of biological matters are bonded and the number has a large variation. This results from that hydrophilic functional groups introduced in during the hydrophilization treatment and contributing to bonding of biological matters execute make molecular chain movement in pure water to reduce the amount of functional groups appearing on the surface of the base in the pure water more than in an acidic solution.

Meanwhile, regarding the adhesiveness of biological matter 120, in Examples 1 to 3 stored in acidic solution 102, the changes of the number of biological matters 120 bonded to biological-matter-adhesive substrate 100 and the variation of the number are reduced. This results from that functional groups introduced during the hydrophilization treatment and contributing to bonding of biological matters does not execute molecular chain movement very much, and more functional groups contributing to bonding of biological matters appear on surface 100A of biological-matter-adhesive substrate 100 in acidic solution 102. Consequently, Examples 1 to 3 have stronger adhesiveness of biological matter 120 onto surface 100A of biological-matter-adhesive substrate 100. It was confirmed that the adhesiveness of biological matters of Examples 1 to 3 was maintained for more than six months, as well as the contact angle to water.

As shown in the above results, the adhesiveness to biological matter 120 is influenced by surface conditions more than the contact angle to water. Therefore, in order to maintain the adhesiveness of biological-matter-adhesive substrate 100 to biological matter 120, biological-matter-adhesive substrate 100 (base 101) is preferably stored in acidic solution 102.

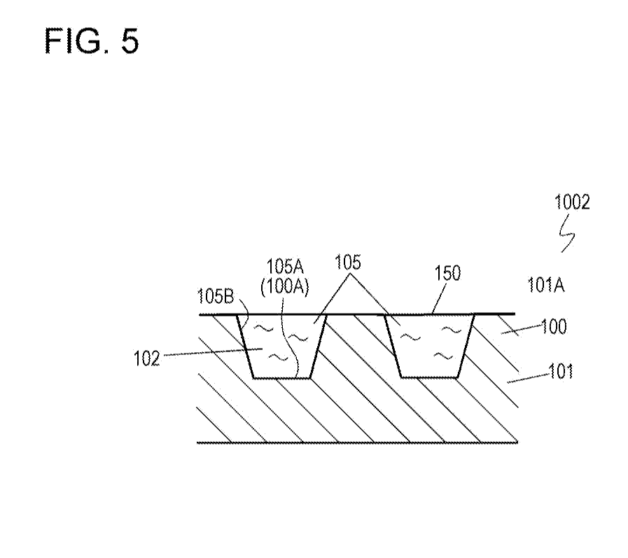

FIG. 5 is a sectional view of another biological-matter-adhesive device 1002 according to the embodiment. In FIG. 5, components identical to those of biological-matter-adhesive device 1001 shown in FIG. 1 are denoted by the same reference numerals.

In biological-matter-adhesive device 1001 shown in FIG. 1, biological-matter-adhesive substrate 100 (base 101) is disposed in acidic solution 102, and both surfaces 101A and 101B are covered with acidic solution 102.

In biological-matter-adhesive device 1002 shown in FIG. 5, cavities 105 are sealed with sheet 150 stuck on surface 101A of biological-matter-adhesive substrate 100 (base 101) while cavities 105 are filled with acidic solution 102. Similarly to biological-matter-adhesive device 1001 shown in FIG. 1, in biological-matter-adhesive device 1002 shown in FIG. 5, bottom surface 105A (surface 100A of base 101) of cavity 105 that is configured to allow biological matters to be bonded onto surface 105A and to have a hydrophilization treatment performed thereto is completely covered with acidic solution 102. Resultantly, the hydrophilicity of bottom surface 105A (surface 100A) and the adhesiveness to biological matter 120 are maintained for a long time.

As described above, according to the embodiment, the adhesiveness of biological matter 120 onto biological-matter-adhesive substrate 100 can be maintained even after biological-matter-adhesive substrate 100 is stored for a long term by disposing, in an acidic solution, base 101 that has a hydrophilization treatment performed thereto, thereby allowing biological matter 120 to be inspected stably.

### INDUSTRIAL APPLICABILITY

A method of maintaining adhesiveness using a biological-matter-adhesive substrate and a biological-matter-adhesive substrate according to the present invention is useful for inspecting and analyzing biological matters, such as cells, blood cells, tissue, and biomolecules.

### REFERENCE MARKS IN THE DRAWINGS

100 biological-matter-adhesive substrate
101 base
102 acidic solution
120 biological matter

1. A biological-matter-adhesive substrate comprising a base having a surface having a hydrophilicity configured to allow a biological matter to be bonded to the surface of the base, wherein the surface of the base is covered with an acidic solution.

2. The biological-matter-adhesive substrate of claim 1, wherein the surface of the base is completely covered with the acidic solution.

3. The biological-matter-adhesive substrate of claim 1,
wherein the acidic solution is contained in a container, and
wherein the base is disposed in the acidic solution.

4. The biological-matter-adhesive substrate of claim 1,
wherein the base is made of a hydrophobic polymer, and
wherein the surface of the base has a hydrophilization treatment performed thereto.

5. The biological-matter-adhesive substrate of claim 4, wherein the hydrophobic polymer is made of one of polystyrene, polymethyl methacrylate, polycarbonate, polypropylene, polyethylene terephthalate, polyethylene, polymethylpentene, polylactic acid, cyclic olefin copolymer, and cyclic olefin polymer.

6. The biological-matter-adhesive substrate of claim 4, wherein the hydrophilization treatment is one of a plasma treatment, a corona treatment, a UV irradiation, and a flame processing.

7. The biological-matter-adhesive substrate of claim 1, wherein the acidic solution contains oxo acid.

8. The biological-matter-adhesive substrate of claim 1, wherein the acidic solution contains one of carboxylic acid, sulfonic acid, and phosphonic acid.

9. A method of producing a biological-matter-adhesive substrate, comprising:
preparing a base having a surface having a hydrophilicity configured to allow a biological matter to be bonded to the surface of the base; and
covering the surface of the base with an acidic solution.

10. The method of claim 9, wherein said covering the surface of the base with the acidic solution comprises completely covering the surface of the base with the acidic solution.

11. The method of claim 9, wherein said covering the surface of the base with the acidic solution comprises disposing the base in the acidic solution.

12. The method of claim 9,
wherein the base is made of a hydrophobic polymer; and
wherein the surface has a hydrophilization treatment performed thereto.

13. The method of claim 12, wherein the hydrophobic polymer is made of one of polystyrene, polymethyl methacrylate, polycarbonate, polypropylene, polyethylene terephthalate, polyethylene, polymethylpentene, polylactic acid, cyclic olefin copolymer, and cyclic olefin polymer.

14. The method of claim 12, wherein said preparing the base comprises performing a hydrophilization treatment to the surface of the base by one of a plasma treatment, a corona treatment, a UV irradiation, and a flame processing.

15. A method of storing a biological-matter-adhesive substrate, comprising:
preparing a biological-matter-adhesive substrate having a surface having a hydrophilicity configured to allow the biological matter to be bonded to the surface of the biological-matter-adhesive substrate; and
storing the biological-matter-adhesive substrate while the surface of the biological-matter-adhesive substrate covered with an acidic solution.
